(19) United States
(12) Patent Application Publication
(10) Pub. No.: US 2009/0217352 A1
(43) Pub. Date: Aug. 27, 2009

(54) Web managed multimedia asset management method and system

(76) Inventors: Tong Shen, New York, NY (US); Lee Morgenroth, New York, NY (US)

Correspondence Address: KENYON & KENYON LLP, ONE BROADWAY, NEW YORK, NY, 10004, US

(21) Appl. No.: 12/072,406

(22) Filed: Feb. 25, 2008

(51) Int. Cl. G06F 15/16; G06F 21/00; G06F 17/30

(52) U.S. Cl. 726/3; 709/217; 707/3; 707/100; 707/E17.009

(57) ABSTRACT

A system for multimedia asset management includes: multimedia assets stored in storage locations, the assets containing collections of associated multimedia files and metadata; a web portal in communications with the storage locations and configured to provide a user access to the assets; a search engine accessible to the user through the web portal and configured, responsive to a user search query, to search for assets based on asset metadata and provide corresponding search results to the user. The web portal is configured: responsive to a user's selection of a selected asset located by the search engine, to provide the user access to the selected asset; and to automatically determine how the asset is presented to the user based, at least in part, on the nature of the user's connection to the storage location storing the selected asset and on an available application on the user's client machine.

### BACKGROUND

The present invention generally relates to a web-based asset management application for multimedia content. More specifically, it relates to providing an electronic asset management application accessible via the World Wide Web, where the individual electronic assets include one or more related media files and associated metadata. The electronic assets may be opened, modified, and saved from a user's resident platform, e.g., a client computer or other client device.

Multimedia or media files include video, music, text, software, project files, or other content and digital datasets. The growth of storage and content has made management of these files problematic. Multimedia asset management systems attempt to address this problem by providing systems to easily store, retrieve, and use these media files. For example, media files may be used in production tools to produce new media files for distribution. Production tools often utilize project files, which include information on media files used and modified in a project.

Previous asset management applications were similar to a file system using a folder structure to organize files. Example folder structure file systems include the Microsoft Windows file folder system. Unfortunately, the folder structure can become large and cumbersome in a multiple-user, multiple-project environment.

Alternatively, asset management applications may be integrated into a particular production tool. Such systems allow easy access to managed media files because of a close integration between the production tool and the asset management application. However, production tools and social networks on the Web that use this approach generally apply a proprietary format or folder structure to the managed media files, thus making it difficult for another production tool to access those media files. In addition, many production tools are “project-based”, and therefore, the media files are locked into specific projects. This makes it difficult for users to share media files across different projects. Example project-based production tools include Apple's Final Cut Pro and Adobe's Premiere media bins. Alternatively, asset management applications can be implemented with custom plug-ins inside the production tool. Software plug-ins can be written specifically to connect an asset management application to a production tool. Unfortunately, this approach requires custom plug-ins for each production tool and requires installing plug-ins on each platform where they will be used. This makes maintenance and upgrades particularly difficult, especially in a multiple-user, multiple-production, and multiple-platform tool environment.

The inventors of the present application have recognized that the World Wide Web offers an opportunity to provide an asset management application accessible to multiple platforms over a geographically spread-out area. Assets may be stored and managed from a central location, while users access the system through the World Wide Web. The vast majority of web sites and web applications serve content through the HTTP protocol, although some older applications serve things through the older FTP protocol. Even existing software tools that allow collaborative work over to a web browser still generally serve content through HTTP.

Thus, the inventors of the present application have recognized a need for a web-based multimedia asset management application that will allow production tools to easily access multimedia assets in a multiple-user, multiple-project, and multiple-platform environment. The inventors of the present application have also recognized a need for an asset management application requiring little or no software installation on end-user platforms for ease of upgrade and maintenance. The inventors of the present application have also recognized a need for not only assets but also functionalities of various application associated with the assets to be hosted by Web servers and accessible through Web browsers.

### SUMMARY

One example embodiment of the present invention is a system for multimedia asset management. The system may include a collection of multimedia assets stored in a plurality of storage locations, the multimedia assets containing collections of associated multimedia files and metadata. The system may also include a web portal in communications with the plurality of storage locations and configured to provide user access to the multimedia assets. The system may also include a search engine accessible to a user through the web-based portal and configured, responsive to a user search query, to search for multimedia assets based on asset metadata and provide corresponding search results to the user. The system may also include a web server configured, responsive to a user's selection of a selected asset located by the search engine, to provide the user access to the selected asset. The web server may be further configured to automatically determine how the asset is presented to the user based, at least in part, on the nature of the user's connection to the storage location storing the selected asset as well on an available application on the user's client machine.

In the example system, the assets may include a plurality of digital multimedia files and associated metadata. Each asset may have a stored object in the repository, the object linking the digital multimedia files and the associated metadata of the asset.

In the example system, the metadata may provide semantic linking between the asset and other assets. The semantic linking may include an indication that an asset has provided content included in another asset. The semantic linking may also include an indication that the asset includes content from another asset. The semantic linking may also include an indication that the asset comments on another asset. The metadata may also include an indication of how many times the asset has been used in the creation of other assets. The semantic linking may also include embedded references to objects, such as web pages that are outside the example system, such as other database repositories or public domain Web portals, such as email applications and utilities, part of media asset (e.g. thumbnail of a video asset), etc.

In the example system, the web server may be further configured to automatically determine how the asset is presented to the user based, at least in part, on at least one of: digital rights management information associated with the asset, the user's permissions, or the presence of a digital key. The web server may be further configured to automatically determine how the asset is presented to the user based, at least in part, on the asset's overall size, the size of a digital file contained in the asset, the format of a file contained in the asset, or the location of the asset. The nature of the user's connection to the storage location may include a connection speed, as well as other properties related to the type of connection. The selected asset may include a plurality of multimedia formats for the same multimedia content, and the web server may be further configured to select one of a plurality of multimedia formats for presentation of the asset to the user which provides the best performance, based on the user's connection speed.

In the example system, the assets may include time-indexed multimedia files and a time frame index linking the multimedia files of the asset. The assets may also include spatially indexed multimedia files and a spatial frame index linking the multimedia files of the asset.

In the example system, the asset metadata may also include cataloging information for the multimedia files of the asset.

In the example system, the search engine may be configured to rank identified multimedia assets based on the number of times the asset has been used in creating other assets. Search results may also be ranked based on other criteria derived from asset metadata, e.g., frequency, such as frequency of access by a particular user or class of users, or the frequency of or the total number of edits, recency, such as the recency of access by a particular user or particular class of users, or the recency of update by a user or particular class of users, proximity with the user's client, presence in a working set of assets accessed by the particular user, etc.

In another example embodiment of the present invention, the assets may be associated with a variety of utilities and functionalities of various applications associated with the assets to be hosted by Web servers and accessible through Web browsers. These applications may also be available through Web Browser independent from assets.

The example system may make available the hosted applications to the users based on user's access level, on user's search requests, workflow requests, or any other generally available or customized Web portal offering criteria of the hosted applications.

In another example embodiment of the present invention, a system may be provided for multimedia workflow management. The system may include a storage repository storing multimedia assets, the multimedia assets including associated multimedia files and metadata, at least some of the metadata including workflow information regarding the asset. The system may also include a browser-based interface including a search engine configured to search for multimedia assets based on the workflow information contained in the metadata.

The example system may also include a workflow metadata schema, the workflow information contained in the metadata being typed according the workflow metadata schema. The workflow metadata schema may be stored in a master XML file stored on the storage repository, and may include the metadata elements from any number and or type of industry standard, open standard, or organizational specific metadata standards.

In the example system, the multimedia assets may further include time-indexed multimedia files and a time frame index linking the time-indexed multimedia files. The time-indexed multimedia files may include multiple types of files of the same multimedia content. The example system may be configured to automatically choose one of the multiple types of files for delivery to a user, based on the job function of that user, or based on other criteria.

In the example system, search masks may be provided. The search masks may be configured to identify a set of files in the repository that are ready to enter a particular step in a multimedia production workflow.

Another example embodiment of the present invention is a multimedia asset stored in a storage repository. The asset may include a plurality of time-indexed multimedia files, a common time frame index linking the time-indexed multimedia files, and a set of metadata providing descriptive information about the asset and the plurality of multimedia files. The metadata may include cross-references to other multimedia assets which have incorporated information from the asset and cross-references to other multimedia assets which have provided content which has been incorporated in the multimedia asset. The multimedia asset may be an object. The metadata in the asset may further include workflow information for multimedia production.

Another example embodiment of the present invention is a method for providing access to multimedia content to a user on a client machine. The method may include receiving a browser request from a user to access the multimedia content; automatically determining the type of connectivity the user has with a repository storing the multimedia content; automatically determining the available applications for using the content the user has available on their client machine; selecting a multimedia file storing the multimedia content from a plurality of different types of files storing the multimedia content, the selection based, at least in part, on the determined type of connectivity and the determined available applications; and serving the multimedia content from the selected multimedia file to the user's client machine.

In the example method, the plurality of different types of files storing the multimedia content may be associated with a common time index. In this case, the method may further include receiving an edited version of the selected multimedia file from the user's client machine, and storing the edited version of the selected multimedia file so that the common time index is preserved. The method may also include, after receiving the edited version of the selected multimedia file, serving the multimedia content to a different user from a different multimedia file from the plurality of different types of files. The multimedia content being presented to the different user may reflect the edits made to the edited version of the selected multimedia file.

Another example embodiment of the present invention is a method of accessing a web-managed multimedia asset. The method may include receiving a user's web browser request to a web-based portal to access a web-managed multimedia asset. The method also includes determining the connectivity of the user's client machine and a repository storing the asset. Responsive to the determination of the connectivity, an access protocol may be selected. Access to the multimedia asset may be provided to the user. The type of the multimedia object provided may depend at least in part on the selected access protocol.

In the example method, the multimedia asset may include a plurality of digital multimedia files and associated metadata. The access to the multimedia asset may be provided by giving access to at least one of the plurality of digital multimedia files in the asset. The selected access protocol may be selected from a group including streaming, progressive downloading, access to a file in shared storage locally accessible to the user's client machine, and access to a file stored on the user's client machine. The selection of the access protocol may depend at least in part on the applications available on the user's client machine, the user's permissions, the speed of the user's client machine, the protocols available, and characteristics of the asset. The user's request may be received from a web browser, and the access may be provided through a web-based portal.

In the example method, determining the connectivity of the user's client machine and a repository storing the asset may occur prior to receiving the user request. The determining of the connectivity of the user's client machine and a repository storing the asset may occur responsive to receiving the user's request.

Another example embodiment of the present invention is an article of manufacture comprising a computer-readable medium storing instructions adapted to be executed by a processor, which cause the processor to perform the methods of accessing a web-managed multimedia asset described above.

According to another example embodiment of the present invention, a system for web-managed multimedia asset management is provided. The system includes an asset management application executing on a server, a storage device in communication with the server and accessible by the asset management application. The storage device may be configured to store at least one electronic asset. The system may include a transmit module in communication with the asset management application, the transmit module configured to transmit a media file of a selected electronic asset over a communications path to a browser responsive to a browser request for the selected electronic asset. The transmitted media file is selected in part in accordance with at least one of (a) a user's access level, (b) a user's computing resource, and (c) a user's intended use of the transmitted media file.

Each electronic asset may include a plurality of related media files and a variable amount of metadata associated with the electronic asset.

The asset management application may be configured to save the media file into the selected electronic asset after modification.

The system may also include a search interface in communication with the asset management application, the search interface may be configured to receive search criteria from the browser, and the asset management application may be configured to transmit a list of stored electronic assets matching the search criteria to the browser.

Accessible stored electronic assets in the asset management application may be determined in part with a user security level or access permissions, the user's role in a workflow process, or the current workflow task the user is working on.

The asset management application may be configured to select the communications link from a set of available communications links, and the selection may be determined in part with a user security level, a user computing environment, an active application and a desired use for the media file.

The storage device may include a local storage device local to the browser and a remote storage device remote from the browser.

The system may include an ingest tool configured to receive a media file and create an electronic asset to be stored in the storage device that includes the media file and associated metadata.

According to another example embodiment of the present invention, a method for providing web-managed, multimedia asset management includes receiving a browser request, the browser request including a search criteria, responsive to the browser request, determining a set of electronic assets matching the search criteria, each electronic asset including a plurality of related media files and a variable amount of metadata associated with the electronic asset, and transmitting a list of the set of electronic assets to a browser.

The set of electronic assets may be retrieved from a storage device configured to store at least one electronic asset.

The method may include transmitting a media file responsive to a user request to receive the media file of a selected electronic asset.

The method may include saving the modified media file into the selected electronic asset responsive to receiving a modified media file.

The media file may be transmitted over a communications link selected from a set of available communications paths, and the selection may be determined, in part, with a user security level, a user computing environment, an active application and a desired use for the media file.

Accessible stored electronic assets may be determined, in part, based on a user's security level, permissions, or the presence of a digital security key.

The set of electronic assets may be stored on a local storage device and/or on a remote storage device.

The method may include receiving a media file, and creating an electronic asset corresponding to the media file including the media file and associated metadata.

According to another example embodiment of the present invention, a computer readable medium may be provided for storing instructions adapted to be executed by a processor to perform a method for providing web managed multimedia asset management. The method includes receiving a browser request, the browser request including a search criteria, responsive to the browser request, determining a set of electronic assets matching the search criteria, each electronic asset including a plurality of related media files and a variable amount of metadata associated with the electronic asset, and transmitting a list of the set of electronic assets to a browser.

The method may include retrieving the set of electronic assets from a storage device configured to store at least one electronic asset.

The method may include transmitting a media file responsive to a user request to receive the media file of a selected electronic asset.

The method may include saving the modified media file into the selected electronic asset responsive to receiving a modified media file.

The media file may be transmitted over a communications path selected from a set of available communications paths, and the selection may be determined in part with a user security level, a user computing environment, an active application and a desired use for the media file.

Accessible stored electronic assets may be determined in part with a user security level.

The set of electronic assets may be stored on a local storage device and a remote storage device.

The method may include receiving a media file, and creating an electronic asset corresponding to the media file, including the media file and associated metadata.

### BRIEF DESCRIPTION OF THE DRAWINGS

FIG. 1 illustrates an example system providing a web-managed, multimedia asset management application, according to an example embodiment of the present invention.

FIG. 2 depicts an example electronic multimedia asset, according to an example embodiment of the present invention.

FIG. 3 depicts two related example electronic multimedia assets with semantic linking provided by metadata, according to an example embodiment of the present invention.

FIG. 4A illustrates an example search request input screen, according to an example embodiment of the present invention.

FIG. 4B depicts an example search result screen, according to an example embodiment of the present invention.

FIG. 4C depicts an open project in a production tool, according to an example embodiment of the present invention.

FIG. 5 depicts an example procedure for accessing an asset, according to an example embodiment of the present invention.

FIG. 6 depicts an example procedure for creating an electronic asset, according to an example embodiment of the present invention.

FIG. 7 depicts an example procedure to search and retrieve an electronic asset from an asset management application, according to an example embodiment of the present invention.

FIG. 8 depicts a procedure to save an electronic asset, according to an example embodiment of the present invention.

FIG. 9 illustrates an example procedure for determining forms in which an asset can be used on a particular client, according to an example embodiment of the present invention.

### DETAILED DESCRIPTION

Some example embodiments of the present invention include systems and methods to provide for management, editing, and use of multimedia in a variety of contexts.

In some example embodiments of the present invention, multimedia assets containing metadata and associated multimedia files and/or objects may be stored at one or a plurality of repositories. The stored multimedia assets may be searched and used by users with a variety of applications. Although in some example systems the assets may be defined using container objects in an object-oriented programming sense, to users the implementation and storage of the assets may be handled transparently. Thus, users who want to listen to or edit music or watch or edit video can deal with the asset as music or video, rather than dealing with the details of the particular objects which contain multimedia information such as files of various file types. The multimedia assets may contain a variety of different formats of multimedia files that may be associated and related, e.g., the original digital recordings of a performance, different versions of edited tracks of a music recording, as well as an edited final product. Other types of multimedia may be stored in the same asset and/or may be linked or copied from other related assets, e.g., a text script, a soundtrack recording, a trailer, and comments by viewers or editors may all be stored in an asset for a theatrical film, semantically linked in various ways with the multimedia object or objects for the theatrical film itself. Similarly, objects of the same basic type may be linked together, e.g., a video as a whole may be linked with individual objects or files each representing a single scene from the video which have been assembled or edited together to form the whole.

In some example embodiments, metadata data may be provided as part of each asset. The metadata may provide searchable semantic information about the asset, about multimedia or other objects or files stored as part of the asset, about relationships between assets, and about relationships between different multimedia objects or files either in the same asset or in different assets. This semantic information may include information about the content, format, history, permissions, and other information about assets or about the multimedia files or objects contained in an asset. This may include, e.g., the identity of the other multimedia assets, objects, or files they were created from, other multimedia they were, in turn, used to create, as well as other history of the asset, such as who, what, when, where and how the asset has been viewed, incorporated into other assets, edited, approved, etc. By providing a rich set of semantic information about multimedia assets, the value and utility of those assets may be greatly increased, e.g., popular or appropriately approved versions of particular multimedia files may be easily located for use in the creation of other multimedia. Some metadata may take the form of textual catalog data associated with assets or objects contained in assets, e.g., field data definitions and associated values which are associated with an asset or with a particular object, file, or set of objects or files contained in the asset. Other metadata may provide semantic links between assets, or between objects or files contained in assets. These links may be provided as links, pointers, references, or simply by having related text index tags with corresponding values. For example, an asset might have the metadata field “Previous Episode:” and subfield “Asset Name”, where the value for the asset name is an identifier of the asset for the previous episode of a multimedia series. Alternatively, instead of the name, a symbolic link, url, or other form of identifier or pointer for the associated asset may be provided.

In some example embodiments, an access interface to the multimedia management system may use a light-weight or even “zero-weight” client, e.g., by being provided entirely, or nearly entirely through a browser-based interface. This may take advantage of users' existing familiarity and comfort with browser-based interfaces, as well as providing a relatively consistent access interface across multiple types of clients. In some example embodiments, a search capability may be provided, e.g., as part of a web portal. The search capability may be similar in appearance to a conventional Internet search engine, but may rely entirely or in part on the metadata that is associated with assets. In this way, users can locate and easily identify multimedia meeting desired search criteria, based on the accumulation of metadata associated with those multimedia assets. The use of standard sets of metadata field definitions allows information to be accumulated about assets shared by a group or enterprise in a manner that makes the metadata and the associated assets, files, and objects easier to access for members of the group or enterprise. As metadata is accumulated for the assets, the utility of the assets, e.g., the organizations or groups ability to re-use the assets increases. The use of simple text metadata descriptors for catalog entries across multiple files and objects of a variety of different types allows even relatively unsophisticated users to use a search engine, with an interface similar to a standard web-browser, to easily locate assets of interest for use or re-use.

In one example embodiment, a method and system are provided for a web managed system of multimedia asset management. Asset management is provided through an asset management application (“AMA”), that may include a storage device, a server processor, a user interface to receive search requests, and a transmit module to transmit a retrieved media file to the user. The asset management system may manage a plurality of electronic assets, each electronic asset including related content, such as media files, and associated metadata. The asset management application provides an interface to users, reducing the need for software installation on user platforms. For example, the interface may be provided in Hypertext Markup Language (“HTML”). In response to user searches, the asset management application retrieves and transmits an appropriate media file from a selected electronic asset. A modified media file is received from the user after editing and saved into the selected electronic asset.

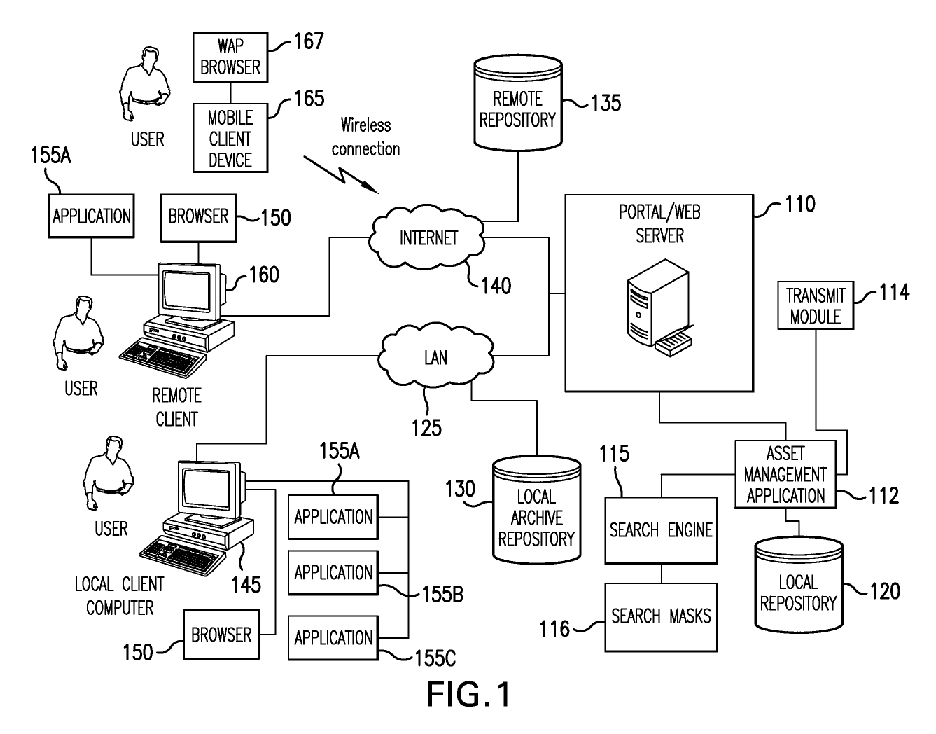

FIG. 1 illustrates an example system providing a web managed multimedia asset management application, according to an example embodiment of the present invention.

Multimedia asset management services may be provided via a portal 110, which may be implemented as a web server, or as any other type of network server. The web server may be provided as a single application on a single computer system, or as multiple distributed applications distributed across several computer systems, e.g., firewall and security, load balancing, routing, etc. However, to the user accessing the system, the distribution of applications across multiple computer systems is provided primarily for management, scalability, and performance, and should be transparent to users at a functional level.

The portal 110 may include or have access to an asset management application 112. The asset management application 112 may provide and control access to electronic assets for one or more users, and may also provide various management and administration functions, such as reporting, security, etc. The asset management application 112 manages access to and use of electronic assets for a variety of users within a network, such as a corporate or enterprise network, as well as for defined groups of users. The asset management application may include or be in communication with a transmit module 114. The transmit module may be configured to determine the most effective way of providing access to a user for an asset, in response to a user's request for access to the particular multimedia asset. The transmit module 114 may be configured to transmit a media file over the network, the browser, or to an active application executing on a user's client machine in response to the user's request for access to the multimedia asset. The transmit module 114 is configured to support a wide variety of network protocols and is configured to determine an optimal delivery protocol and path for a media file. The transmit module 114 may also be configured to automatically determine in which available form a multimedia asset should be provided to the user, e.g., depending on the available applications on the user's client, and the type of network connection, the user's identity and permissions, etc. For example, a user accessing the multimedia asset via a low speed connection might be automatically provided access to a lower resolution, smaller multimedia file specifically configured for such access.

The portal 110 may also provide user access to a search engine 115. The search engine 115 may be provided with a similar interface to a conventional Internet search engine, with additional functions particularly tailored for searching for and selecting multimedia assets. The search engine 115 may be configured to allow users to search, using various criteria, for multimedia assets throughout the system which meet the criteria.

Provided as part of, or in a location accessible to, the search engine may be a set of search masks 116. Search masks 116 may serve as filters for searches for assets launched by users. For example, sets of search masks may be provided for various roles in the media production process (such as producers of a particular series, editors, sound editors, etc.). Search masks may also be provided for particular tasks, so that the search engine can be used to control workflow by producing a filtered result that shows assets that have completed a certain step in a production workflow, or which are ready for a particular task to be performed. Search masks may have multiple rules and may depend on metadata values associated with assets. Some search masks may be defined administratively, e.g., work groups and their associated permissions; others may be customized for particular users or purposes.

For example, a user performing a quality control role for a particular production organization, may have a search mask that identifies all assets associated with their production organization, which may be combined with a search mask that identifies all assets that have had all of their pre-QC processing workflow tasks completed. The result of these two masks being applied to the set of assets in the system would yield a set of assets that constitute the current work queue for that QC task. The user could set these masks as defaults, and then add additional search query properties, e.g., all assets associated with another person who had inquired about the status of a task, to easily locate a particular asset of interest.

The web server 110 may have local access to a local repository 120 on the same computer system, or on other computer located in the same or a close location as the web server, e.g., connected via a high speed local area network in the same geographic location. The local repository 120 may include a database, conventional file system, or other software system storing multimedia assets of various types and formats, which may be stored electronically as files or in other computer-accessible forms on any conventional storage media, including optical storage, disk arrays, etc.

The portal 110 may also have local access to local archive or repository 130 or other local repositories which store multimedia assets. The access may be provided through a LAN 125. Access may also be provided to multimedia assets at a remote repository 135 via a wide area network such as the Internet 140. The access to local and remote storage may be managed by the asset management system, or, alternatively, may be provided transparently to the asset management system through the use of distributed database techniques.

Users may access the portal and use multimedia assets from the different repositories in a variety of ways from a variety of different types of clients or resident platforms. The client machine may be a personal computer, a personal digital assistant, a cell phone, a wireless device, or any other computing device configured to execute the browser. The clients may include local clients geographically co-located with the portal, remote clients connected via a network such as the Internet, or clients connected wirelessly. For example, a user may access the asset management application 112 via the portal 110 from a personal computer 145 which has high-speed LAN access to the portal 110. The client may be running a browser 150 which may be used to access the Internet, including the portal/web server 110. Because access is local, e.g., via the high speed LAN 125, there will be fewer bandwidth or latency constraints on the user or on the downloading of multimedia to the user's local client computer. The access may be made using a browser 150 on the client. The local client computer 145 may have a variety of applications 155a, 155b, 155c, e.g., installed programs or browser plug-ins that can be used with multimedia assets accessed via the portal. These applications may include viewing and editing tools for various types of multimedia. An application may be a production tool, a media viewer, a media editor, etc. For example, production tools are applications such as Apple Final Cut or Adobe After Effects. A media viewer or editor allows a user to view or edit a video file, an image file, an audio file, or a text file. Media viewers and editors are commonly available and typically support a wide variety of standard formats. It will be appreciated that different users and different local client computers may have different sets of installed or available applications. The asset management application may also detect which of the available applications are currently running on the system, as an open or active application. The way the portal/web server reacts to a request may depend on the available applications, and on the currently running or active applications on the client computer. On occasion, the portal/web server may also cause the client to begin executing (or even load) a new application, e.g., a browser plug-in required to view a particular type of content. It will be appreciated that any number of applications may be installed and accessible on the client, while only three are depicted in FIG. 1.

Alternatively, a user may use the portal to access multimedia assets from a remote client computer 160 via the Internet 140. The remote client computer may have a browser and applications similar to the local client computer 145, although the exact set of available installed applications may vary from user to user and client computer to client computer.

Users may also access the portal 110 via a wireless network, e.g., a wireless internet connection from a mobile device 165, such as a cell phone, a PDA, a personal entertainment device with wireless connection, or even a personal computer connected wirelessly. The protocols used and available applications for such access may be different than for the wired network access in order to provide effective access via a wireless connection. The tools available on the wireless client may be particularly tailored to be suitable for use in a wireless environment. For example, a WAP browser 167 may be provided in addition to or in place of a conventional web browser.

In one alternative example embodiment, digital production tasks that require access to high definition files may be centralized, or the files co-located with persons assigned those tasks. Remote storage may then be used for archival storage, or to store smaller or lower-definition electronic assets for which high-speed real-time network access is not required. For example, video files which are intended to be streamed could be stored on remote storage. In contrast, video files which require high-speed access for editing are stored in local storage, or are migrated, using data migration systems, to storage close to where they are needed. Various conventional data warehousing techniques may be employed to control where and when particular assets are stored, backed-up, or archived.

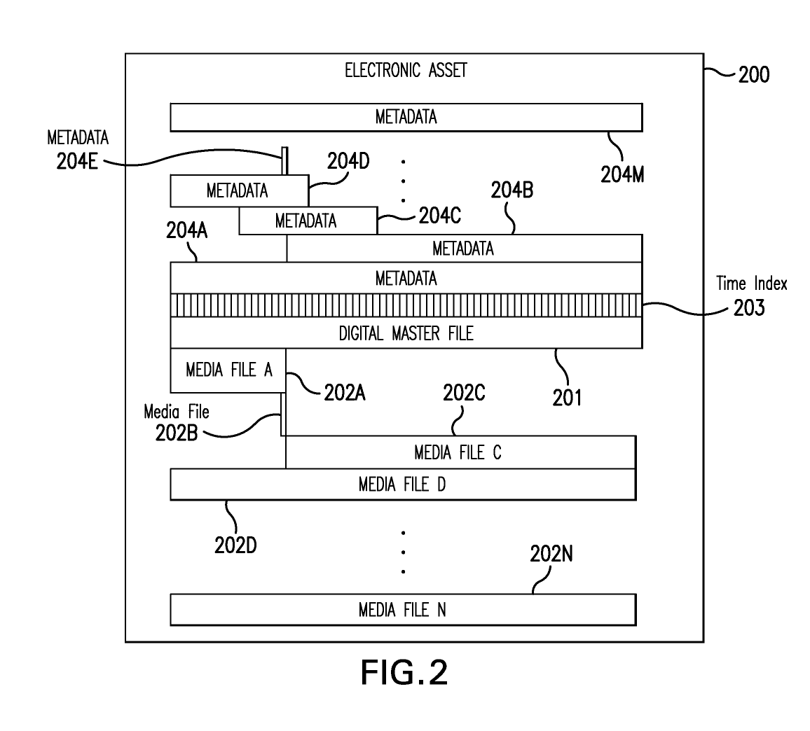

FIG. 2 depicts an example multimedia asset, according to an example embodiment of the present invention. In some example embodiments, assets may serve as containers for multimedia files and for metadata. Some assets may also contain only metadata, without multimedia files. The metadata provides semantic information including semantic linkages for the asset, the multimedia files, and between assets and multimedia files.

Illustrated example multimedia asset 200 includes a digital master file 201 and a time index 203. The illustrated asset 200 is a time-indexed multimedia asset, such as an audio or video asset. The time index 203 corresponds to a time/temporal dimension in the digital master file 201. Adding new portions to or deleting portions from the digital master file will result in corresponding changes to the time index. Changes to the time index, e.g., deleting or rearranging portions of the digital master, or adding new sequences to the digital master, may be propagated throughout all of the media and metadata in the asset. This may also change references to the asset that are contained in other assets. In other embodiments, the time index may be replaced by other forms of indices for the asset, e.g., a two-dimensional spatial index for assets related to still image production, or a three-dimensional spatial index for assets representing three-dimensional models or plans. A time index (or spatial index) may link different, related media files that share a common time index. This may facilitate editing and viewing, e.g., edits applied to a particular media file may then be automatically applied or reflected in new versions of related media files having a common time index. Also, since users of media files often access them using the index, they can then use (or view or listen to) corresponding segments of related media files having the common time index, e.g., watching the video portion while listening to or editing a separate soundtrack file.

In addition to the digital master file 201, the asset may contain a plurality of media files that may be linked to the digital master file. A media file 202 may be any video, audio, image, text, project file, or other multimedia file stored in an asset management application. While FIG. 2 only depicts five media files or objects, 202A, 202B, 202C, 202D, and 202N, it will be understood that any quantity of media files may be included within an electronic asset. Each of the media files in the asset 200 is associated with a portion of (or all of) the time index 203. For example, if the asset were a television episode, media file 202A might be a standard series introduction, and would be linked to the initial segment of the time index for the asset. Media file 202B may represent a single frame or still image, e.g., a copyright notice, that is linked to a single time point in the time index. Media file 202D is co-extensive with the entire time index 203 and digital master file 201 and may represent, e.g., a soundtrack for the asset 200, or different representations of the digital master file formatted for use with different sorts of applications. It will be appreciated that, in a spatially-indexed asset, the media files would be similarly linked to the spatial index of the digital master file.

The asset may also include metadata 204, which may also be associated with the asset time index 203. Metadata may provide semantic information regarding all or part of the asset, as well as providing semantic linkages with other assets. Each piece of metadata may be associated with all or a particular part of the time index for the asset. Metadata associated with the entire asset may be linked to the entire time index of the asset. Each metadata may have a description or type, and a value.

The metadata may provide semantic information of various types and for all or part of the asset. For example metadata 204A is associated with the entire asset, and is therefore illustrated in FIG. 2 as being associated with the entire time index 203 of the illustrated asset 200. Metadata 204A includes semantic information related to the asset as a whole, but not necessarily linked directly to any particular object or file contained in the asset. For example, metadata 204 may include an access timestamp for the asset, a creation timestamp, a last modified timestamp, text, such as a description, a title, a list of keywords, an abstract, etc. or any other text associated with the electronic asset as a whole, a user ID, such as a creator, a last user who accessed the electronic asset, an access history, etc. or any other user ID information, links to websites or other resources related to the electronic asset.

Metadata 204B, 204C, and 204D, may be associated with particular subsets of the time index. These files may be particular components which have been mixed, concatenated, or combined in other ways to create the digital master file, or which are derived from the digital master file. Metadata 202B is associated with a particular time segment of the asset, e.g., the TV episode mentioned above without the standard introduction. Metadata 204E may be associated with a single frame of the asset, for example, information that is also related to media file 202B which is located at the same point in the time index. For example, metadata 204E might be a query or note attached by an editor at a particular time point in the asset.

It will be appreciated that the number of media files in the asset does not have to equal the number of metadata. Large amounts of metadata may be associated with the asset as a whole, e.g., to provide bibliographic, historical, and access control information for the asset as a whole.

The media files contained in an electronic asset may be different format files associated with the same basic multimedia content. For example, a high resolution video media file, a lower resolution video media file, various versions of the audio soundtrack for the video media file, a text version of the content such as a script or editorial commentary, and other formats may all be stored in the electronic asset, and all linked with the common time index of the digital master file.

The different media files of an electronic asset may also store different time segments of the asset. For example, a final video file may be broken down into different segments, and each segment is stored in a separate media file of an electronic asset, while they are all concatenated in the digital master file.

A particularly useful type of metadata may provide semantic linking between different assets, or between particular portions of different assets.

The illustrated electronic asset may be provided as a container object defined by an object class in Java, C or other object-oriented programming environment, or alternatively, using other approaches to implementing computer data structures. Other object classes may be defined for the various types of media files and for metadata. The example electronic asset illustrated may include semantic relationships between media files and metadata, as well as between the asset and metadata, and between different media files. This semantic context provides information associating appropriate media files and metadata with the electronic asset, as well as with other assets and files. It should be understood that other arrangements are also possible. For example, some of the metadata provided in example embodiments of the present invention may be in the Dublin Core or Public Broadcasting (PB) core, which provide standards for metadata descriptions for multimedia assets. The Dublin Core metadata element set provides a standard set of fields for cross-domain description of information resources, including multimedia files as illustrated herein. The Dublin Core and PB Core provide naming conventions to make multimedia items easier to find online. Dublin Core has been used to describe digital materials such as video, sound, image, text, and composite media like web pages. Implementations of Dublin Core typically make use of XML, a standard markup language. Dublin Core is defined by the Dublin Core Metadata Initiative, a standards group, and is documented as ISO standard 15836. The PB Core was defined by the Corporation for Public Broadcasting, and version 1.1 became available in the first quarter of 2007. It will be appreciated that other standard and/or custom metadata definitions may also be employed.

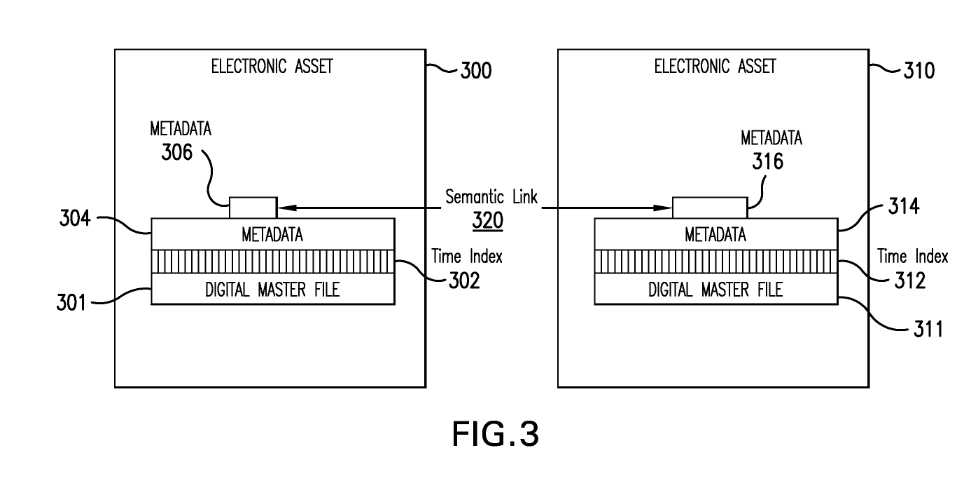

FIG. 3 depicts two related example electronic multimedia assets with semantic linking provided by metadata, according to an example embodiment of the present invention. Illustrated asset 300, has digital master file 301, time index may be, e.g., a video asset such as a news clip or original news footage of a politician's speech. Metadata 304 may identify the asset and provide background information on the clip. A second electronic asset 310 may have digital master file 311, time index 312, and general metadata 314. The asset 310 may be a second video asset, such as a second video of a different speech by the same politician. An editor may add metadata 306 to electronic asset 300 and metadata 316 to asset 310 to form a semantic link 320 between two portions of the respective news clips that show the politician taking inconsistent positions. The associated metadata may be labeled with additional semantic information, such as text tag indicating an “inconsistency” or “flip-flop”. If users flags multiple such linkages with a consistent naming convention, it will be very easy for users to search for and locate all assets with such links.

It will be appreciated that the semantic link 320 may be provided with a variety of different approaches. The illustrated semantic link is a two-way link with metadata corresponding to particular time segments in both related assets. A one-way link could also be provided in just one of the assets, which references in one asset a particular portion of the time index in another asset. The disadvantage of that approach is that when the “linked to” asset is altered, the link may be corrupted. However, this problem should not arise if the “linked to” asset is archival and locked against change in some manner. A further alternative approach would be to provide the semantic link in a separate metadata only asset (or as a part of another asset) that has references to both of the two assets 300 and 310. The semantic link may be provided by, e.g., shared metadata values, or by explicit linkage, with an HTML link. The value of the link may be encoded in the value of the metadata.

Multiple users may use example systems described herein to add additional semantic contact to an entire library of multimedia content. By adding semantic content to assets, the value and utility of the assets may be greatly increased. It will be appreciated that the example is provided for illustration, and that multimedia assets containing numerous different types of multimedia linked in an effectively infinite variety of arrangements may be handled. For example, links may be provided between an asset for a film, and asset for the theatrical trailer for the film, and an asset for the Internet trailer for the film, and assets including commentary on the film assets. A producer could flag various assets with comments for potential use at a later date in a documentary, e.g., a photo and a quote which the editor think would be representative of a particular topic.

It will be appreciated that these assets are simplified for illustration, and in actual practice might contain many more additional elements and metadata than is discussed and illustrated here. Moreover, it will be appreciated that the information in the separate assets could also be combined together in a single asset, or further subdivided into additional assets. It should also be appreciated that semantic linking to sources other than an entire media asset may be provided, such as email applications, web pages, individual parts of media asset, e.g. thumbnail of a video asset, etc.

In some example embodiments of the present invention, users may access the multimedia asset management system through a web portal. Depending on the type of access permissions required, a user may log in through a browser using conventional secure web login technology. After login, a user may be provided with a standard browser type interface to the multimedia asset management system, including search capability, ability to “ingest” or add additional multimedia files to the system, as well as other capabilities. Standard browser menu commands 402 and iconic browser buttons 404 available to the user provide standard browser commands, such as back, forward, refresh, stop loading, load a pre-set home page, etc. Using a standard browser interface has the advantage of providing a familiar and easy-to-use interface to users who may not be comfortable with a more technical interface.

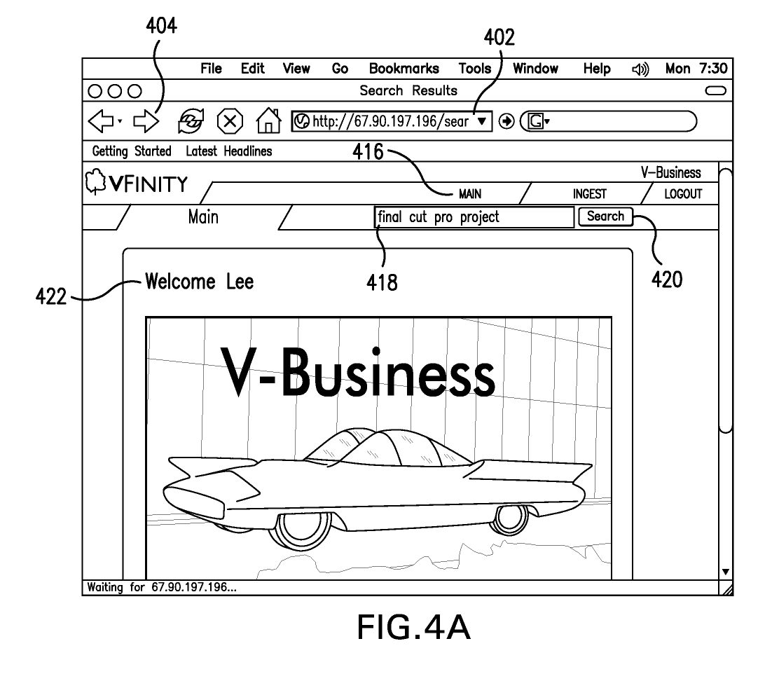

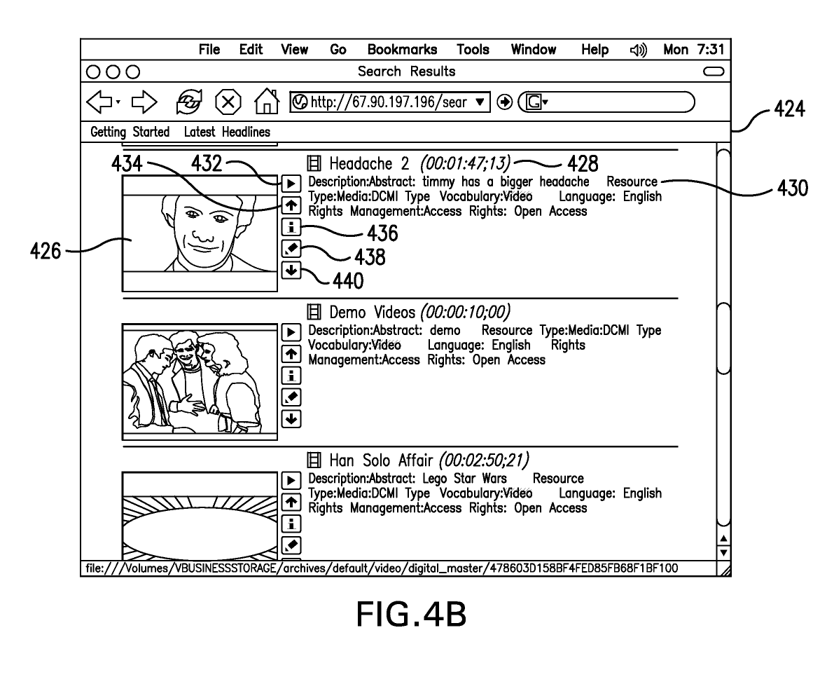

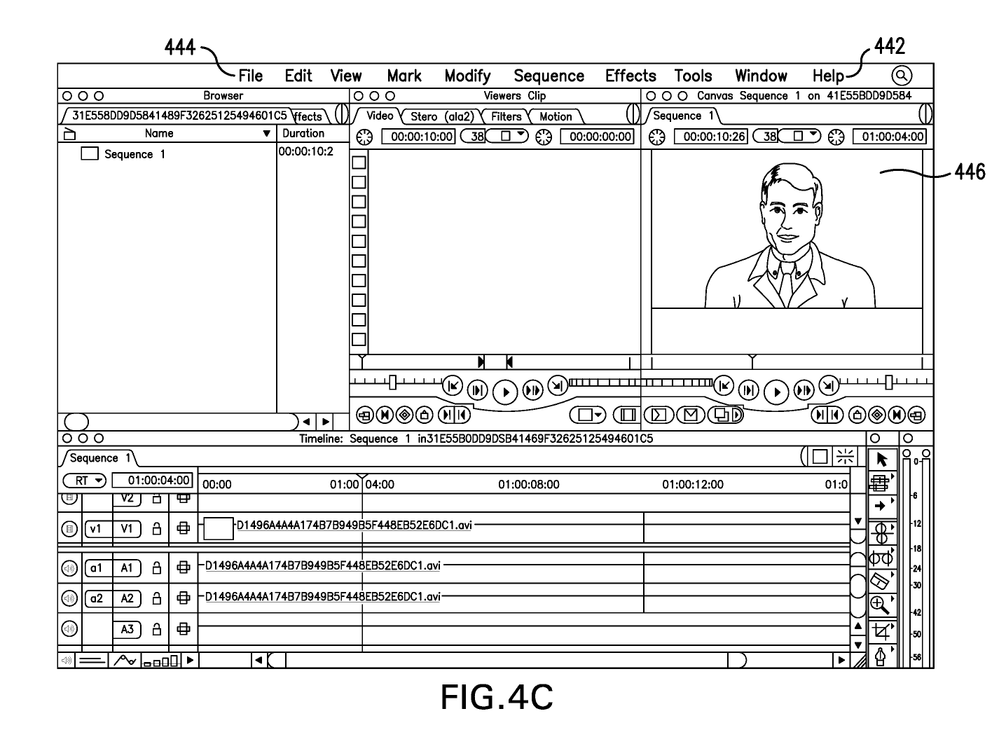

FIG. 4A illustrates an example user access screen for a browser-based asset management application, according to an example embodiment of the present invention. The asset management application may provide a menu of options 416 to the user, including going to a main page, ingesting media (e.g., inputting new or existing media files into the asset management system), logging out, etc. After logging in, the asset management application provides a search field 418 and a search button 420, similar to a conventional search engine, but focused on a search of the asset management system and the metadata contained therein. For example, the search engine, may, but need not necessarily, be focused entirely on searching assets by metadata text found in the assets. The user enters search criteria, for example, text describing an electronic asset and/or its associated metadata, in the search field 418. After the search criteria have been entered, the user clicks the search button 420 or hits return to proceed with the search. The asset management application searches metadata associated with each stored electronic asset to find electronic assets that fulfill the search criteria. In addition, search masks based, for example, on the user's identity, permissions, role in the workflow process, available applications, client connectivity, or preferences may also be applied to the search results. The search masks may include rules for filtering search results based on asset metadata values. Search masks may be applied before results are displayed, e.g., implicitly denying access to certain assets based on a user identity or work group.

FIG. 4B illustrates an example user access screen showing a search result, according to an example embodiment of the present invention. After search criteria have been entered in the search field 418 and the user has initiated a search, the asset management application returns a set of search results 424. Unlike a conventional Internet search engine which returns web page addresses, or a file searcher which returns files, the example asset management system returns as a search result a list of assets in the asset management system that have metadata which satisfy the search criteria entered by the user. The search results 424 include one or more result entries, such as result entry 426. The result entry 426 includes information related to the electronic asset as well as a representative graphic, such as a thumbnail created automatically or designated by the creator of the asset.

Information related to the electronic asset is stored in the asset management application as metadata associated with the electronic asset, or with media files contained in the asset. A title of the electronic asset 428 may be displayed to the user, as well as various metadata 430 describing the electronic asset. For example, metadata includes a description, an abstract, a resource type, a language, a rights management scheme, an application associated with the electronic asset, etc. and/or any other information. In accordance with standard metadata conventions, the metadata here is shown as one or more levels of metadata definition, followed by a metadata value. For example, for the first asset shown in the search results illustrated in the figure, “Rights Management” is a metadata category, with a subcategory “Access Rights”, with the value of “Open Access” for the particular asset displayed in the search results.

The search result screen also may provide buttons or other input widgets which represent actions a user may execute on a selected electronic asset. For example, button 432 allows a user to preview the asset, for example, by viewing a reduced size and bit rate version of the asset directly in the browser, or in an appropriate browser plug-in. Alternatively, other preview approaches may also be provided depending on the particular application and user preferences, e.g., a thumbnail scene index, or some other convenient and efficient approach to previewing the asset without launching the full application required to work with the asset. Button 434 initiates an automated launch of a media file or application project file associated with the electronic asset into an open project of an active application or a desktop or locally running production tool or application. If no running instance of the application is available, the production tool or application may be initiated and loaded into local memory, and the media file may be inserted into an open project of an active application. Button 436 allows a user to retrieve information regarding the electronic asset. For example, information of an electronic asset includes the metadata associated with the electronic asset. Button 438 allows a user to edit the electronic asset, e.g., by adding additional metadata. Button 440 allows a user to download the electronic asset.

FIG. 4C depicts an open project in a production tool. The production tool 442 may be as previously described and include a menu 444. The menu 444 includes actions available to the user in the production tool. A display 446 displays a currently opened project. The production tool includes other displays and receives inputs from the user in order to modify the project, e.g., to edit a particular media file in the asset, or to create edits that will apply to media files sharing a common time index in the asset. As depicted in FIG. 4C, a project file is loaded and may include a video file and project information. The production tool may receive a plurality of media files from the asset management application, which are manipulated to create a final media file or project file.

A project may be saved on the asset management application as a media file within an electronic asset. Metadata associated with the electronic asset may include a list of all electronic assets and media files which were used in order to create the project, the date of last modification, the user who made the last modification, etc. and other metadata related to the use and production of the project in the production tool.

Example procedures to create, retrieve, and save an electronic asset from the asset management application of an example embodiment of a the present invention will be described below.

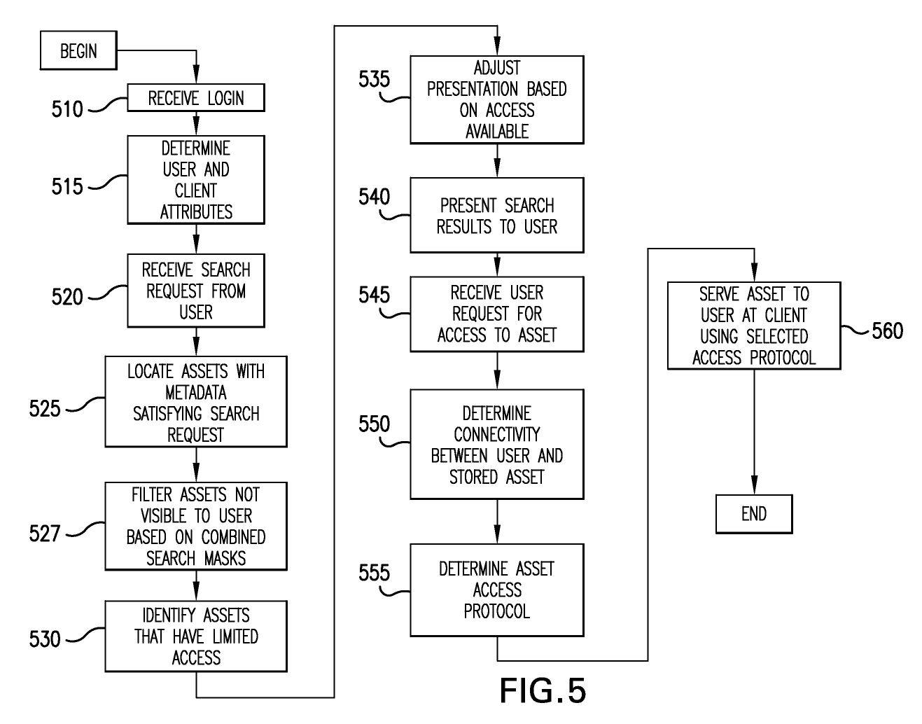

FIG. 5 illustrates an example procedure for accessing an asset, according to an example embodiment of the present invention. The example procedure may be performed using the example asset management system described previously in the present application, or with other systems.

In 510, a user login may be received. It will be appreciated that the login may be received using any conventional secure web access technology. It will also be appreciated that different types and levels of security, e.g., the use of secure RSA devices, biometric identification, or other information may optionally be required, depending on the nature of the materials being accessed and the type of access being requested, e.g., write or editing access may require a higher level of security than read access.

In 515, attributes of the user and the user's client machine may be determined. For example, the user's demographic or job function information, the speed of the user's connection, and the available applications on the user's client machine may all be determined, either by look-up based on the user's identity, or by manual or automatic query. Attributes about the user may be determined both based on permissions and based on preferences, for example, the user's role in a media production process may be defined by permissions associated with their identity, or may be selected as a user preference as a user moves from task to task. A hybrid of the two approaches would limit the roles that users could choose from to those that they are allowed to have by their permissions. User preferences may also be inferred by having the user select particular previously defined searches which are designed for their particular task or role.

In 520, a search request may be received from the user, e.g., in the search toolbar of the system described previously in the present application. The search may simply be a list of keywords, or may alternatively take other forms. In 525, the database of available assets may be searched based on the search request received from the user. The search may be performed using precompiled search indices, or an actual search of the database may be performed. Assets with metadata matching the search request from the user may be identified and located.

In 527, assets in the search request whose existence is not viewable to the user can be filtered out of the search results. This may be done both for security and for work efficiency. For example, users might not be allowed to view assets from outside their work groups, for security reasons. At the same time, a user working in a particular role might prefer to only see search results that are pertinent to their particular production task. It will be appreciated that whether the user's search results show the existence of certain assets merely indicate one filtering attribute that involves the user and the assets, and that additional filtering or permissions may be performed with various other types of access rights, discussed in more detail below. In one embodiment, filtering may be accomplished by using predefined search masks associated administratively with particular work groups. Other filtering may be accomplished with search masks based on user attributes, e.g., job title or user id. The search masks may include rules that are applied to asset metadata in order to select a subset of the search results that should be displayed. These rules may be multi-part and may also depend on the values of multiple metadata fields.

It will be appreciated that the masking of undisplayed search results may be performed as a separate task as shown in the illustrated procedure, or may alternatively be integrated with the actual search process, so that assets that would be filtered are eliminated as part of the search query.

In 530, the user's available forms of access to the various assets in the search results may be determined. The various forms of access which may be allowed or restricted may include, e.g., read only access, the ability to add metadata to the asset, the ability to edit existing metadata, the ability to edit or change the digital master form of the asset, the ability to export media content from the asset and the ability to alter access controls associated with the asset. Access rights may be individual or group based. Access rights may be determined based, at least in part, on asset metadata. Access control may also be provided for particular pieces of metadata, e.g., certain metadata for an asset could be locked so that it cannot be changed or deleted.

Assets with restricted or limited access may be identified based on the permissions or preferences of the user, e.g., some users may only be permitted certain types of access to certain assets based on access control or security requirements. Assets with restricted or limited access may also include assets for which the user lacks appropriate applications to view the asset, or has a connection with insufficient bandwidth or computer capacity to view the asset successfully. Asset access control may be determined based in part by the user's preferences, for example, a user may be performing a particular job task or function from among various functions they fulfill, so that they could obtain the appropriate permissions, but choose only to view or access assets in a manner consonant with their current task. It will be appreciated that some forms of certain assets may be unusable by certain users, but these assets may have alternative forms. For example, a high resolution digital master may not be practically downloaded over a wireless connection, but the same asset might also include a highly compressed lower bit rate version of the same asset which is suitable for such use. However, an asset without such an alternative form might be effectively unusable by a user in that context. It will be appreciated that, instead of screening out search results that are unusable, alternatively, they could still be displayed in the search results but flagged as unusable, or in another alternative, simply moved to the end of the search results.

In 535, assets in the search results that may not be accessed by the user may be screened out of the search results. Such assets may include assets for which the user lacks appropriate permissions to access. It will be appreciated that, in some cases, assets may be available to users for limited access, for example, for read access but not for write access. In such a case, the permitted forms of access may be noted in the search results so that the status of the search results are communicated to the user making the search. It will be appreciated that alternatively, the search could be conducted so that such assets are never produced as part of intermediate search results. For example, buttons or other controls permitting types of access which are restricted or unavailable, may be omitted, or alternatively may be grayed out.

In 540, the search results may be presented to the user. Information, such as metadata associated with each asset located by the search, may be presented with identification of the search results. The search results may also reflect, e.g., by including appropriate icons, the types of access to each located asset that are available to the user who made the search from their current client machine and location. Each asset entry displayed in the search result may also have an associated thumbnail, a text title, or other indicia indicating the contents of the asset. Metadata associated with the asset may also be displayed with the search result, either in its entirety, or in an abridged form.

In 545, the user may indicate their desire to access an asset that is part of the search results, for example, by clicking on a representative thumbnail corresponding to one of the assets in the search results.

In 550, the connectivity between the selected asset and the user's client machine may be determined. This information may be determined in real-time by analyzing the user's connectivity when an asset is requested, or may be derived from information collected when the user logs into the system or at periodic intervals. Other information regarding the user and their client may also be determined, for example, client speed and available hardware, available applications on the client, the client's permissions with respect to the particular selected asset, etc. It will be appreciated that the user connectivity might be determined at login, instead of when an access is made. However, when assets are distributed in multiple locations, the type of connection available may depend on the location of the particular asset requested at the time access to the asset is requested.

In 555, based at least in part on the nature of the user's connectivity, but also on the user's permission and the nature of the user's client, the appropriate access protocol for the user to access the selected asset may be determined. For example, if the user has limited permissions and a low speed connection, a low quality version of the asset may be provided, e.g., a small size video that is streamed. At a slightly higher connection rate, a progressively downloaded image of a larger size may be provided. If the client is connected via a high speed connection, the highest quality version of the asset may be provided. The nature of the access protocol may also be adjusted depending on demographic information about the user, for example, their role in a production process. For example, a sound editor might need the highest quality version of sound files, but only need a representative low speed version of a video object. As part of selecting the access protocol, the type of access the user is allowed to the asset may also be determined, e.g., whether the user has the ability to edit the asset, or to edit particular elements of the asset, e.g., a user might have the permission to add comments and notes to the asset without the permission to edit the underlying multimedia objects in the asset.

In 560, the asset may be served to the user at the user's client using the access protocol that was selected in 555.

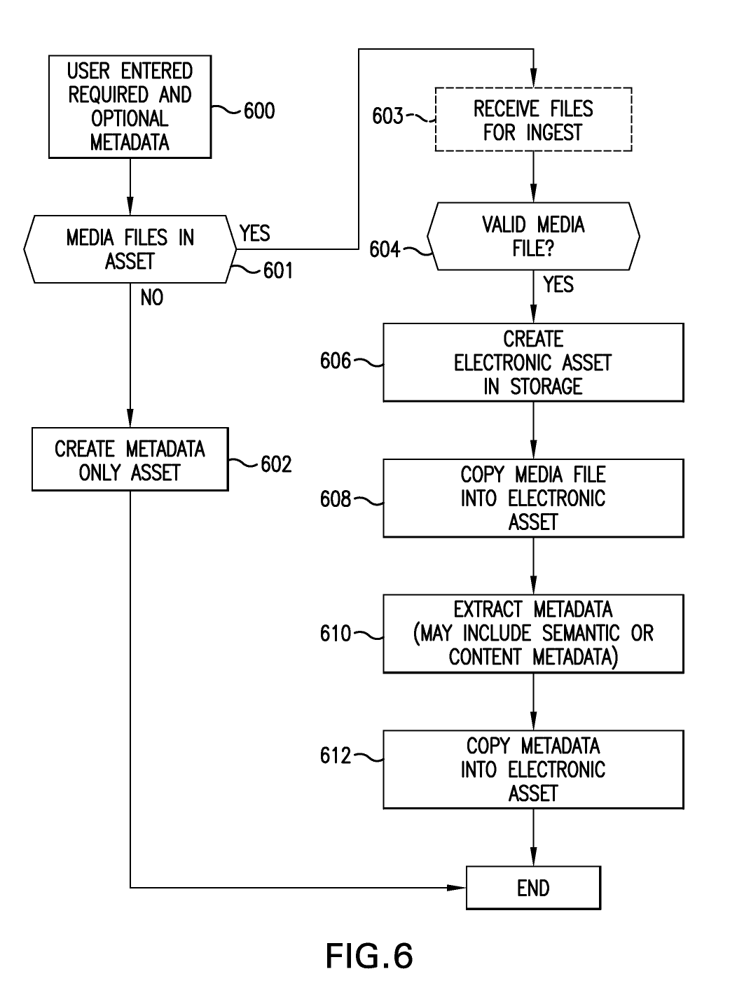

FIG. 6 depicts a procedure for creating an electronic asset. In 600, a user may enter any required and optional metadata to be associated with the electronic asset to be created. Metadata may be as described above. In 601, if the user is creating a metadata only asset, the example procedure may proceed to 602, and a metadata only asset may be created. It will be appreciated that additional metadata may also be added after the asset is created. If an asset containing media files is to be created, the example procedure may proceed to 603.

In 603, an asset management application optionally receives media files to ingest. For example, a user may upload one or more media files from which electronic assets may be created. A special folder on the user's resident platform, monitored by the asset management application, may be utilized. Media files placed into the special folder are automatically loaded by the asset management application which creates corresponding electronic assets. A tool available on a user's resident platform may be provided which transmits a media file and any metadata to be associated with the media file to the asset management application.

Prior to receiving the media file for ingest, the user may be prompted to enter required metadata to be associated with the media files. This metadata is placed into the created electronic asset and can be held in quarantine until the media file is received or exists in a valid electronic asset as a placeholder or metadata-only electronic asset.

In 604, the asset management application checks whether the media file is valid. For example, the asset management application checks that the media file is in a standard format and is not corrupted. A wide variety of multimedia formats may be supported, for example, video, graphic, image, audio, text formats, etc. If the media file is valid, the procedure proceeds to 606.

In 606, the asset management application creates an electronic asset in a storage device in which to store the media file. For example, the electronic asset may be as illustrated in FIG. 2. The asset management application may initialize the object as described above. The electronic asset may include a plurality of related media files and a dynamic amount of metadata.

In 608, the asset management application copies the received media file into the electronic asset created in 606. The asset management application also updates the electronic asset to reflect the received media file, by adding metadata to the electronic asset relating to the newly received media file, such as a timestamp of when the media file was added, a user ID associated with the user who added the media file, a file name and properties of the received media file etc. or any other information.

In 610, the asset management application performs media analysis or processing to extract or infer metadata from the file or files and adds this metadata to the asset. The extracted metadata may include both semantic data related to the asset as a whole, and content related metadata derived from the media content of the asset. The metadata may be acquired in an automated fashion or from user input. Automated metadata includes date of creation, file name of the media file, size of the media file, format of the media file, etc. or similar information. User-inputted metadata includes a description of the media file, a title of the electronic asset, comments and feedback associated with the media file, or any other such information and may be inputted at any time after the electronic asset is created. After the metadata is received and validated, the metadata may be copied into the electronic asset in 612, e.g., by the asset management system. At this point, the electronic asset may be complete. It should be understood that the electronic asset may now be used and modified in the system as described elsewhere. It will be appreciated that additional media files and metadata may be added to the asset after the asset has been created.

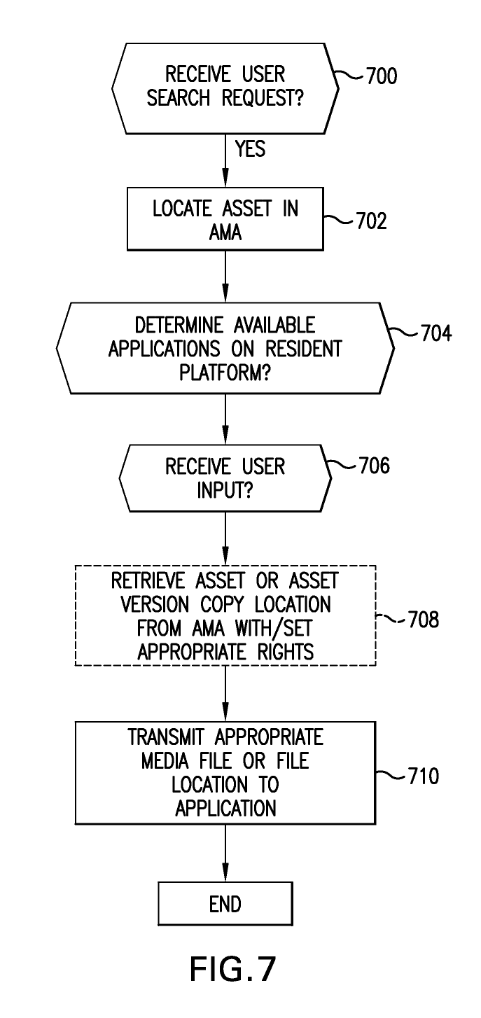

FIG. 7 depicts an example procedure to search and retrieve an electronic asset from an asset management application. The retrieved electronic asset may have been previously created through a procedure as illustrated in FIG. 6. In 700, the asset management application tests whether a user search request has been received. For example, a user search request is received from a browser interacting with the user. The search request is received through a search interface provided to the browser by the asset management application. If yes, the procedure proceeds to 702.

In 702, the asset management application searches accessible storage device to locate electronic assets matching the user search request. For example, the storage devices may be local or remote. The storage devices may be broken up into the multiple distributed devices. The user search request includes user-inputted text. The asset management application searches metadata associated with stored electronic assets for metadata text that matches the user search request.

In 704, the asset management application may determine supported applications on the resident platform. For example, the resident platform may have installed a number of applications which include production tools or multimedia content viewers and editors. The user may concurrently execute one or more installed applications on the resident platform.

In 706, the asset management application tests whether a user input indicating a user desire to open the electronic asset has been received. If yes, the procedure proceeds to 708.

In 708, the asset management application optionally retrieves the electronic asset or relevant metadata/media files of the electronic asset with appropriate rights from a storage device. Alternatively, a file location may be retrieved.

The electronic asset may be retrieved for use by the user with exclusive read/write rights. This will prevent any other user from accessing the electronic asset for modification while the user is using the electronic asset. This prevents multiple versions of the electronic asset from being present in the asset management application.

Alternatively, the electronic asset may be retrieved with read-only rights. A read-only electronic asset may be used by the user, but is never saved back into the asset management application. For example, if a user only wishes to add a segment of a video clip from an electronic asset to an existing project, read-only access to the video clip media file may be all that is required. Other forms of read/write access schemes may be implemented.

In 710, the asset management application communicates to a transmit module to transmit an appropriate media file to the active application. For example, an appropriate media file may be determined based on network traffic and congestion, intended use of the media file, available network connections to the asset management application, and the security level of the user or context that the user is in.

Alternatively, the location of the appropriate media file or project file to the media file or project file loading interface of the active application may be transmitted.

For example, if a video file is to be streamed, it is transmitted from a remote storage device via a streaming protocol. For rough editing, a proxy may be used to provide access to the asset. But if a video file is to have more sophisticated video editing or modification performed, the asset's location may be transmitted to a loading interface of the editing application for direct use. Users may have a security level indicating whether they are entitled to such high-speed access to media files.

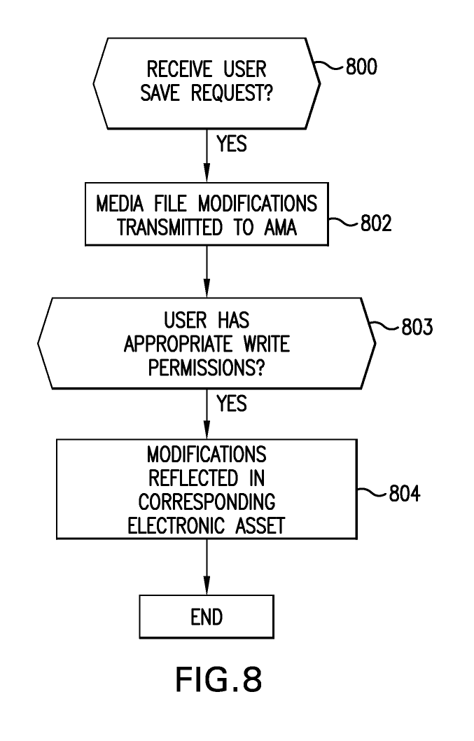

FIG. 8 depicts an example procedure to save a new version of an electronic asset. In 800, the asset management application receives a user save request. The user may have previously retrieved a media file from a selected electronic asset through the procedure illustrated in FIG. 7.

In 802, an application executing on a resident platform accessible to the user transmits media file modifications to the asset management application. After a user has modified the media file on the resident platform, it is sent back for saving through the asset management application onto a storage device. If the media file or project file has been used by reference location, changes made to these files through the application on the resident platform are reflected in the media files of the asset.

In 803, whether the user has appropriate permissions may be verified before the modifications are permanently made to the asset. It will be appreciated that access control may also be performed earlier in the process, so that, e.g., only users with appropriate access permissions are allowed to even initiate the save process.

In 804, the asset management application saves the changes to the media file into a corresponding electronic asset, taking into account the access rights granted to the user. For example, if the access right was an exclusive read/write right, the changes are saved into the electronic asset, and the electronic asset returned to the asset management application for future access. If the access right was read-only, an error message is generated, and the attempt to save the media file is halted. The asset management application may also add or update metadata associated with the electronic asset when a modified media file is saved.

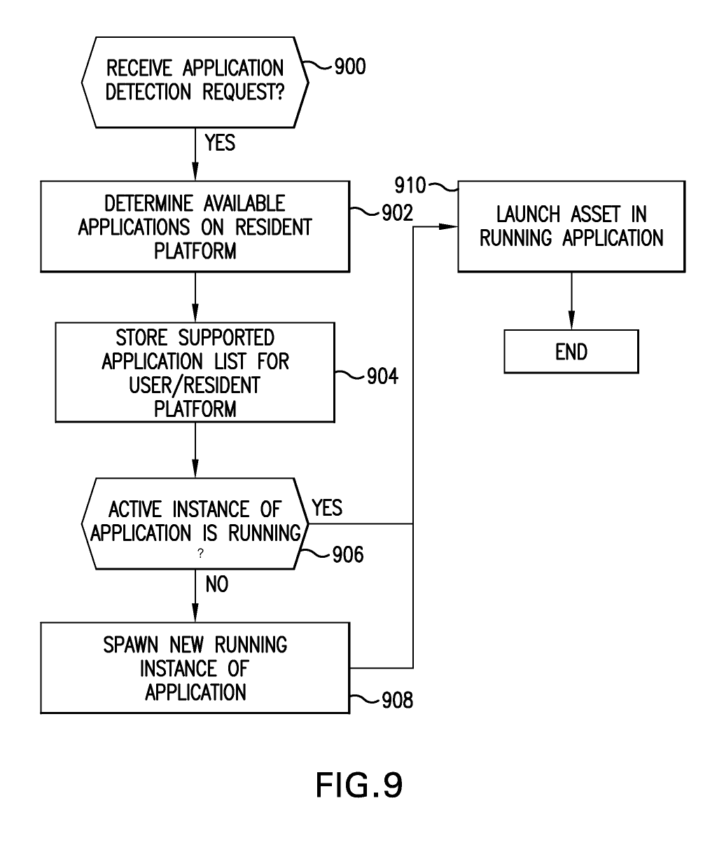

FIG. 9 depicts an embodiment of a procedure to detect an active application on a resident platform. The procedure may be implemented as a Java applet executing on the resident platform. Alternative embodiments, such as a local application, are also possible. It will be appreciated that the example procedure could be easily modified to detect not only active applications, but also available applications which are not presently active, e.g., software tools which are present on the user's client machine but not presently loaded in memory or running.

In 900, the applet may receive a request to detect an active application from an asset management application, as depicted in FIGS. 1 and 3.

In 902, the applet may determine the active application on the resident platform. For example, the applet may interface with an operating system of the resident platform to determine an active window, and an application executing in the active window. It will be appreciated that the applet may also look for installed but currently inactive applications, particularly if no appropriate active application is found.

In 904, the applet may store a supported application list for the user or resident platform. The list may be stored on the resident platform or on the asset management application and be used in future accesses by the user.

In 906, when the user wants to access an asset with a supported application, it may be determined whether an instance of the particular application is running. If no instance is running, a new instance of the application may be spawned in 908. IN 910, the asset may be launched in the running application.

Thus, a web managed system of multimedia asset management may greatly reduce software requirements at end-user platforms. Media files may be managed in a multi-user, multi-platform, and multi-project environment. Each electronic asset accessible by the asset management application includes related media files and metadata. A media file is extracted from a selected electronic asset and transmitted to a user for use, and received from the user after use for saving into the selected electronic asset.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions, performs or facilitates the performance of all or part of the disclosed methods and procedures.

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than a restrictive sense.

1. A system for multimedia asset management, comprising:
a collection of multimedia assets stored in a plurality of storage locations, the multimedia assets containing collections of associated multimedia files and metadata;
a web portal in communications with the plurality of storage locations and configured to provide a user access to the multimedia assets;
a search engine accessible to the user through the web portal and configured, responsive to a user search query, to search for multimedia assets based on asset metadata and provide corresponding search results to the user;
the web portal configured, responsive to a user's selection of a selected asset located by the search engine, to provide the user access to the selected asset, the web portal further configured to automatically determine how the asset is presented to the user based, at least in part, on the nature of the user's connection to the storage location storing the selected asset and on an available application on the user's client machine.

2. The system of claim 1, wherein an asset includes a plurality multimedia files embodying the same multimedia in different formats.

3. The system of claim 2, wherein the plurality of multimedia files in the asset embodying the same multimedia share a common time index.

4. The system of claim 3, wherein one of the plurality of multimedia files embodying the same multimedia is a digital master file.

5. The system of claim 4, wherein the common time index is derived from the time index of the digital master file.

6. The system of claim 2, wherein the plurality of multimedia files embodying the same multimedia share a common spatial index.

7. The system of claim 6, wherein one of the plurality of multimedia files embodying the same multimedia is a digital master file.

8. The system of claim 7, wherein the common spatial index is derived from the spatial index of the digital master file.

9. The system of claim 2, further comprising:
an access control system configured to control the user's access to the selected asset based, at least in part, on the selected asset's metadata.

10. The system of claim 9, wherein the types of access which are controlled based on the asset's meta data are selected from the group consisting of:
informing the user of the selected asset's existence,
allowing the user to view the metadata and a proxy representation of the selected asset without access to the digital master file of the asset,
allowing the user to edit the selected asset's metadata,
allowing the user to export the selected asset's digital multimedia files,
allowing the user to alter the selected asset's digital master file.

11. The system of claim 10, further comprising:
a set of search masks accessible to the access control system, the search masks each including a rule which permits a particular type of access for a group of users to a set of assets based on a value of a metadata element of the assets in set of assets.

12. The system of claim 11, wherein the asset management system is further configured, based on the search masks, to forbid a particular type of access for the group of users to other assets based on a value of the metadata elements of the other assets.

13. The system of claim 9, wherein the types of access to hosted applications which are controlled based on the asset's meta data are selected from the group consisting of:
allowing the user to view the metadata and a proxy representation of the selected asset without access to the digital master file of the asset,
allowing the user to edit the selected asset's metadata,
allowing the user to export the selected asset's digital multimedia files,
allowing the user to alter the selected asset's digital master file,
allowing the user to make collections of assets,
allowing the user to create versions of assets,
allowing the user to apply digital rights management restrictions to the assets,
allowing the user to generate distribution profiles for single or multiple distribution channels,
allowing the user to ingest media files as new asset or as a new version of existing asset,
allowing the user to import other archives,
allowing the user to export assets in the system,
allowing the user to edit one or multiple assets independently,
allowing a plurality of users to edit one or multiple assets as a group for a production project,
allowing the user to perform an editing function on a Web browser,
allowing the user to perform an editing function of the assets in the system in the resident client,
allowing the user to create semantic linking to other assets in the system,
allowing the user to create semantic linking to objects, web pages, or partial objects outside the system,
allowing the user to notify other users through browsers or through emails,
allowing the user to associate a Web application or local application in the resident client to the system, the association enabling the application to be used in conjunction with the system.

14. The system of claim 3, wherein the multimedia files in the asset include a digital master file and a set of multimedia files derived from the digital master file.

15. The system of claim 2, wherein each asset has a stored object in the repository, the object associating the digital multimedia files and the associated metadata of the asset.

16. The system of claim 2, wherein metadata includes data definitions and associated values.

17. The system of claim 16, wherein at least some of the metadata provides a semantic link between the asset and an other asset.

18. The system of claim 17, wherein the metadata in the asset providing semantic linking includes a link to the other asset and a meaning for the link to the other asset.

19. The system of claim 18, wherein the semantic link is provided as metadata searchable by the search engine.

20. The system of claim 16, wherein the metadata includes data describing all of the contexts of use for the asset for all of the users of the asset.

21. The system of claim 20, wherein the contexts of use for the asset include viewing the asset, editing the asset's metadata, editing multimedia files in the asset, commenting on the asset, approving the asset, and incorporating content from the asset in another asset.

22. The system of claim 17, wherein the semantic link includes a mapping from the time frame index of the asset including the semantic link to the time frame index of the other asset which is referenced by the semantic link.

23. The system of claim 22, wherein the other asset includes an indication that the asset has a semantic link referencing a portion of the time frame index of the other asset.

24. The system of claim 17, wherein the semantic linking includes an indication that the asset comments on the other asset.

25. The system of claim 1, wherein the web portal is further configured to automatically determine how the selected asset is presented to the user based on the identity of the user in the system.

26. The system of claim 1, wherein the web portal is further configured to automatically determine how the selected asset is presented to the user based on metadata values of the selected asset.

27. The system of claim 1, wherein the web portal is further configured to automatically determine how the selected asset is presented to the user based, at least in part, on at least one of digital rights management information associated with the selected asset, the user's permissions, or the presence of a digital key.

28. The system of claim 1, wherein the web portal is further configured to automatically determine how the selected asset is presented to the user based, at least in part, on the selected asset's overall size, the size of a digital file contained in the selected asset, the format of a file contained in the selected asset, or the location of the selected asset.

29. The system of claim 1, wherein the nature of the user's connection to the storage location includes a connection speed.

30. The system of claim 1, wherein the nature of the user's connection to the storage location includes an access protocol.

31. The system of claim 28, wherein the selected asset includes a plurality of multimedia formats for the same multimedia content, and wherein the web portal is further configured to select one of a plurality of multimedia formats for presentation of the asset to the user which provides the best performance, based on the user's connection speed.

32. The system of claim 1, wherein the selected asset includes time-indexed multimedia files and a time frame index linking the multimedia files of the selected asset.

33. The system of claim 32, wherein at least some of the metadata of the selected asset references portions of the time index of the selected asset.

34. The system of claim 32, wherein all of multimedia files in selected asset are linked to the time frame index.

35. The system of claim 32, wherein catalog metadata for the selected asset are linked to specific portions of the time framework of the selected asset.

36. The system of claim 1, wherein the selected asset includes spatially-indexed multimedia files and a spatial frame index linking the multimedia files of the selected asset.

37. The system of claim 2, where the selected asset's metadata includes cataloging information for the multimedia files of the selected asset, and wherein the selected asset is identified by the search engine responsive to the user search query based on the cataloging information.

38. The system of claim 37, wherein the cataloging information includes information conforming to at least one metadata standard chosen from the group consisting of: PBCore, Dublin Core, SMEF, MXF, AAF, HL7, or DICOM.

39. The system of claim 2, where the selected asset's metadata includes rights management information for the multimedia files of the selected asset, and wherein the selected asset is identified by the search engine responsive to the user search query based on the rights management information.

40. The system of claim 2, where the selected asset's metadata includes workflow management information for the multimedia files of the selected asset, and wherein the selected asset is identified by the search engine responsive to the user search query based on the workflow management information.

41. The system of claim 2, where the selected asset's metadata includes notification information for the selected asset.

42. The system of claim 2, where the selected asset's metadata includes semantic linking information including at least one of: a description of the nature of the link, a relationship associating the asset with a user, a relationship associating the asset with a group of users, a visual representation of a linked asset, or an automation trigger for an application that works with the selected asset.

43. The system of claim 1, wherein the search engine is configured to rank identified multimedia assets based, at least in part, on the number of times the asset has been used in creating other assets.

44. The system of claim 1, wherein the search engine is configured to rank identified multimedia assets based, at least in part, on the number of semantic links to the assets.

45. The system of claim 44, wherein the search engine is configured to rank identified multimedia assets based, at least in part, on the number of times the asset has been at least one of: viewed, edited, accessed for versioning, accessed for publishing, or accessed for distribution.

46. The system of claim 44, wherein the search engine is configured to rank identified multimedia assets based, at least in part, on at least one of: the number of collections the asset belongs to or the frequencies of the metadata of the asset being used in other assets.

47. The system of claim 1, wherein the search engine is configured to rank identified multimedia assets based, at least in part, on at least one of: the number of applications being deployed on the asset, the number of times an application has been used with the asset.

48. The system of claim 47, wherein the applications are provided as part of the system.

49. The system of claim 47, wherein the applications are provided from outside the system.

50. The system of claim 47, wherein the search engine is configured to rank identified multimedia assets based, at least in part, on the number of automation processes linking to the asset.

51. The system of claim 1, wherein the search engine is configured to rank identified multimedia assets based, at least in part, on access statistics associated with a user or group of users.

52. The system of claim 1, wherein the search engine is configured to rank identified multimedia assets based, at least in part, on at least one of the number of publishing channels the asset has been put through, the number of distribution channels the asset has been put through, or the number of exports the asset has been put through.

53. The system of claim 2, wherein the metadata includes an indication of how many times the asset has been used in the creation of other assets.

54. The system of claim 1, further comprising:
a plurality of hosted applications associated available through the web portal.

56. The system of claim 54, wherein a least some of the hosted applications are associated with particular assets.

56. A system for multimedia workflow management, comprising:
a storage repository storing multimedia assets, the multimedia assets including associated multimedia files and metadata, at least some of the metadata including workflow information regarding the asset; and
a browser-based interface including a search engine configured to search for multimedia assets based on the workflow information contained in the metadata.

57. The system of claim 56, further comprising:
a workflow metadata schema, the workflow information contained in the metadata being typed according the workflow metadata schema.

58. The system of claim 57, further comprising:
a master XML file storing the workflow metadata schema

59. The system of claim 58, wherein at least some of the schema elements correspond to video production tasks.

60. The system of claim 59, wherein the video production tasks are selected from the group consisting of approval, status, review, and editing.

61. The system of claim 57, wherein at least some of the schema elements correspond to audio production tasks.

62. The system of claim 61, wherein the audio production tasks are selected from the group consisting of approval, status, review, and editing.

63. The system of claim 56, wherein the multimedia assets further comprise time-indexed multimedia files and a time frame index linking the time-indexed multimedia files.

64. The system of claim 63, wherein the time-indexed multimedia files include multiple types of files of the same multimedia content.

65. The system of claim 64, wherein the system is configured to automatically choose one of the multiple types of files for download to a user, based on the job function of that user.

66. The system of claim 56, wherein a plurality of saved searches are provided, the saved searches each configured to identify a corresponding set of files in the repository that are ready to enter a particular step in a multimedia production workflow.

67. A multimedia asset stored in a storage repository, comprising:
a plurality of time-indexed multimedia files;
a common time frame index linking the time-indexed multimedia files; and
a set of metadata providing descriptive information about the asset and the plurality of multimedia files, the metadata including cross-references to other multimedia assets which have incorporated information from the asset and cross-references to other multimedia assets which have provided content which has been incorporated in the multimedia asset.

68. The multimedia asset of claim 67, wherein the asset is an object.

69. The multimedia asset of claim 68, wherein the metadata further includes workflow information for multimedia production.

70. The multimedia asset of claim 69, wherein the time-indexed multimedia files include a digital master file and plurality of alternate format multimedia files having the same multimedia as the digital master file in other formats, the alternate format multimedia files sharing a common time frame index with the digital master file.

71. A method for providing access to multimedia content to a user on a client machine, comprising:
receiving a browser request from a user to access the multimedia content;
automatically determining the type of connectivity the user has with a repository storing the multimedia content;
automatically determining the available applications for using the content the user has available on their client machine;
selecting a multimedia file storing the multimedia content from a plurality of different types of files storing the multimedia content, the selection based, at least in part, on the determined type of connectivity and the determined available applications; and
serving the multimedia content from the selected multimedia file to the user's client machine.

72. The method of claim 71, wherein the plurality of different types of files storing the multimedia content are associated with a common time index, the method further comprising:
receiving an edited version of the selected multimedia file from the user's client machine; and
updating the common time index based on the changes made to the edited version of the selected multimedia file.

73. The method of claim 72, further comprising:
after receiving the edited version of the selected multimedia file, serving the multimedia content to a different user from a different multimedia file from the plurality of different types of files, the multimedia content presented to the different user reflecting the edits made to the edited version of the selected multimedia file.

74. A method of accessing a web-managed multimedia asset, comprising:
receiving a user's web browser request to a web-based portal to access a web-managed multimedia asset;
determining the connectivity of the user's client machine and a repository storing the asset;
responsive to the determination of the connectivity, selecting an access protocol; and
providing access to the multimedia asset to the user, the type of the multimedia object provided depending at least in part on the selected access protocol.

75. The method of claim 74, wherein providing access to the user includes exporting a multimedia file from the asset to user.

76. The method of claim 75, wherein the multimedia asset includes a plurality of digital multimedia files and associated metadata.

77. The method of claim 76, wherein the request to access the asset is for a particular purpose, further comprising:
granting access to the user to the asset for the particular purpose based, at least in part, on the user's identity and the metadata of the asset.

78. The method of claim 76, wherein the access to the multimedia asset is provided by giving access to at least one of the plurality of digital multimedia files in the asset.

79. The method of claim 75, wherein the selected access protocol is selected from a group including streaming, progressive downloading, access to a file in shared storage locally accessible to the user's client machine, and access to a file stored on the user's client machine.

80. The method of claim 75, wherein the selection of the access protocol depends at least in part on the applications available on the user's client machine, the user's permissions, the speed of the user's client machine, the protocols available, and the characteristics of the asset.

81. The method of claim 75, wherein the user's request is received from a web browser, and wherein the access is provided through a web-based portal.

82. The method of claim 75, wherein determining the connectivity of the user's client machine and a repository storing the asset occurs prior to receiving the user's request.

83. The method of claim 75, wherein determining the connectivity of the user's client machine and a repository storing the asset occurs responsive to receiving the user's request.

84. A system for web managed multimedia asset management, comprising:
an asset management application executing on a server;
a storage device in communication with the server and accessible by the asset management application, the storage device configured to store at least one electronic asset, each electronic asset including
a plurality of related media files, and
a variable amount of metadata associated with the electronic asset; and
a transmit module in communication with the asset management application, the transmit module configured to transmit a media file of a selected electronic asset over a communications path to a browser responsive to a browser request for the selected electronic asset;
wherein the transmitted media file is selected in part in accordance with at least one of (a) a user access level, (b) a user computing resource, and (c) a user's intended use of the transmitted media file.

85. The system of claim 84, wherein the asset management application is configured to save the media file into the selected electronic asset after modification.

86. The system of claim 84, further comprising a search interface in communication with the asset management application, the search interface configured to receive search criteria from the browser, the asset management application configured to transmit a list of stored electronic assets matching the search criteria to the browser.

87. The system of claim 84, wherein accessible stored electronic assets in the asset management application are determined in part based on the identity of the user and the asset metadata.

88. The system of claim 84, wherein the asset management application is configured to select the communications link from a set of available communications links, the selection determined in part with a user security level, a user computing environment, an active application and a desired use for the media file.

89. The system of claim 84, wherein the storage device includes a local storage device local to the browser and a remote storage device remote from the browser.

90. The system of claim 84, further comprising an ingest tool configured to receive a media file and create an electronic asset to be stored in the storage device that includes the media file and associated metadata.

91. A method for providing web managed multimedia asset management, comprising:
receiving a browser request, the browser request including a search criteria;
responsive to the browser request, determining a set of electronic assets matching the search criteria, each electronic asset including a plurality of related media files and a variable amount of metadata associated with the electronic asset, the determining based, at least in part, on the metadata of the electronic assets; and
transmitting a list of the set of electronic assets to a browser.

92. The method of claim 91, wherein the set of electronic assets are retrieved from a storage device configured to store at least one electronic asset.

93. The method of claim 91, further comprising transmitting a media file responsive to a user request to receive the media file of a selected electronic asset.

94. The method of claim 93, further comprising saving the modified media file into the selected electronic asset responsive to receiving a modified media file.

95. The method of claim 93, wherein the media file is transmitted over a communications link selected from a set of available communications paths, determined in part with a user security level, a user computing environment, an active application and a desired use for the media file.

96. The method of claim 91, wherein accessible stored electronic assets are determined in part with a user security level.

97. The method of claim 91, wherein the set of electronic assets are stored on a local storage device and a remote storage device.

98. The method of claim 91, further comprising:
receiving a media file; and
creating an electronic asset corresponding to the media file including the media file and associated metadata.

99. A method for managed multimedia asset management, comprising:
automatically determining profiles of users or system usage access types;
analyzing groupings of the users or usage access types;
automatically populating metadata of an asset with user behavior and usage data of one of the users, or a group of users, or group of groups of users, or of applications or systems accessing the asset, the usage data including at least one of
usage data of groups the user belongs to,
usage data of groups the application system belongs to, or
usage data of groups created by the multimedia asset management system based on the behavior of the user or the application system.

100. The method of claim of 99, further comprising:
displaying through a Web browser at least one of groupings, rankings, collections, relationship among the groups, ranks based on automatically generated user behavior data, collections based on automatically generated user behavior data, ranks based on automatically collected application system behavior data, or collections based on automatically collected applications system behavior data.

101. The method of claim of 99, further comprising:
determining what groups, collections, or ranks to automatically display based on the user and user's usage of the system, the usage being at least one of: which function button users cursor is pointing at, which access page user is at, which system interface other systems are accessing, or user access privilege.

102. The method of claim of 99, further comprising:
populating the metadata of the asset with the increasing use of the ranking information, grouping information, and collection information.

103. The method of claim of 99, further comprising:
making recommendations to users based on automatic data analysis; and
providing access to an asset based on the recommendations.

104. (canceled)
